(19) United States
(12) Patent Application Publication
(10) Pub. No.: US 2014/0175025 A1
(43) Pub. Date: Jun. 26, 2014

(54) GENERATION OF LOW-SOLIDS SECOND MOTHER LIQUOR FROM TEREPHTHALIC ACID PRODUCTION FILTER

(71) Applicant: EASTMAN CHEMICAL COMPANY, KINGSPORT, TN (US)

(72) Inventor: KENNY R. PARKER, AFTON, TN (US)

(73) Assignee: EASTMAN CHEMICAL COMPANY, KINGSPORT, TN (US)

(21) Appl. No.: 14/084,707

(22) Filed: Nov. 20, 2013

Related U.S. Application Data
(60) Provisional application No. 61/740,766, filed on Dec. 21, 2012.

(51) Int. Cl. B01D 29/56; B01D 33/00

(52) U.S. Cl. CPC B01D 29/56; B01D 33/0006
USPC 210/758; 210/806; 210/783

(57) ABSTRACT

Disclosed is a process for separating solids from liquid in a slurry. The process is characterized by using two filtration media. One filtration medium contains less than 10 mm in thickness of a filter cake containing the solids, and the other filtration medium contains at least 10 mm in thickness of a filter cake containing the solids. The second filtration medium has a higher separation efficiency that the first filtration medium. The process is particularly useful for separating terephthalic acid solids from an oxidation product slurry.

### CROSS-REFERENCES TO RELATED APPLICATIONS

This application claims priority under 35 U.S.C. §119(e) to U.S. Provisional Application Ser. No. 61/740,766 filed on Dec. 21, 2012.

### FIELD OF THE INVENTION

The invention generally relates to a process for separating solids from liquid in a slurry by filtration.

### BACKGROUND OF THE INVENTION

Terephthalic acid (TPA) is an intermediate in the production of polyesters for plastics and fiber applications. A typical commercial process for manufacturing TPA includes oxidizing p-xylene in the presence of a heavy-metal catalyst and a bromide promoter in an acetic acid solvent. Due to the limited solubility of TPA in acetic acid under practical oxidation conditions, a slurry of TPA crystals is formed in the oxidation reactor. Typically, the TPA crystals are withdrawn from the reactor and separated from the reaction mother liquor using conventional solid-liquid separation techniques.

The mother liquor, which contains most of the catalyst and promoter used in the process, is recycled to the oxidation reactor. Aside from the catalyst and promoter, the mother liquor filtrate also contains dissolved TPA and many by-products and impurities. These by-products and impurities arise partially from minor impurities present in the p-xylene feed stream. Other impurities arise due to the incomplete oxidation of p-xylene resulting in partially oxidized products. Still other by-products result from competing side reactions in the oxidation of p-xylene to terephthalic acid.

Many of the impurities in the mother liquor recycle are relatively inert to further oxidation. Such impurities include isophthalic acid, phthalic acid, and trimellitic acid, for example. Impurities that undergo further oxidation are also present, such as, for example, 4-carboxybenzaldehyde, p-toluic acid, and p-tolualdehyde. The concentration of oxidation inert impurities tends to accumulate in the mother liquor stream. The concentration of these inert impurities will increase in the mother liquor until an equilibrium is reached whereby the amount of each impurity contained in the dry TPA product balances its rate of formation or addition to the oxidation process. The normal level of impurities in crude TPA makes it unsuitable for direct use in most polymer applications.

Traditionally, crude TPA has been purified either by conversion to the corresponding dimethyl ester or by dissolution in water with subsequent hydrogenation over standard hydrogenation catalysts. More recently, secondary oxidative treatments have been used to produce polymer-grade TPA. Irrespective of the method used to purify TPA to render it suitable for use in polyester manufacture, it is desirable to minimize the concentrations of impurities in the oxidation mother liquor and thereby facilitate subsequent purification of TPA. In many cases, it is not possible to produce a purified, polymer-grade TPA, unless some means for removing impurities from the recycled mother liquor is used.

One technique for removing impurities from a recycle stream commonly used in the chemical processing industry is to draw out or “purge” some portion of the recycle stream. Typically, the purge stream is simply disposed of or, if economically justified, subjected to various treatments to remove undesired impurities while recovering valuable components. The amount of purge required for control of impurities is process-dependent; however, a purge amount equal to 10-40% of the total mother liquor filtrate is usually sufficient for TPA manufacture. In the production of TPA, the level of mother liquor purge necessary to maintain acceptable impurity concentrations, coupled with the high economic value of the heavy-metal catalyst and solvent components of the mother liquor, make simple disposal of the purge stream economically unattractive.

TPA product filters can allow a small portion of TPA solids to escape the filter with the mother liquor. The concentration of solids in the product filter mother liquor can be as high as 0.5 wt %. It is undesirable, however, to have solids in the mother liquor feed to the filtrate purge zone of a TPA process. The solids can increase the capital costs and energy requirements of the purge process. Also, solids in the filtrate comprise TPA and represent a yield loss if they exit the process in the purge waste. A tighter filter medium can be installed in the filter to prevent TPA solids from breaking through. But this option will have a negative impact on the filtration rate and the required filtration area. Therefore, it is not an acceptable solution to this problem.

The normally practiced method for clarifying the filtrate from a TPA product filter is to pass the filtrate through a batch pressure candle filter or a decanter centrifuge, prior to feeding it to a purge process. This method is a viable solution to the problem, but it is relatively expensive. A less expensive method for providing a low-solids feed to a TPA purge process is needed.

The present invention aims to address this need as well as others, which will become apparent from the following description and the appended claims.

### SUMMARY OF THE INVENTION

The invention is as set forth in the appended claims.

Briefly, in one aspect, the present invention provides a process for separating solids from liquid in a slurry. The process comprises the steps of: (a) contacting a first portion of a slurry comprising solids dispersed in a liquid with a first filtration medium to produce a first filtrate; (b) contacting a second portion of the slurry with a second filtration medium to produce a second filtrate; and (c) passing the first filtrate and the second filtrate to different locations. The first filtration medium comprises less than 10 mm in thickness of a filter cake comprising the solids. The second filtration medium comprises at least 10 mm in thickness of a filter cake comprising the solids. The second filtrate comprises a lower solids content than the first filtrate.

In another aspect, the present invention provides a method for generating a low solids content terephthalic acid oxidizer purge feed stream. The method comprises the steps of: (a) contacting a first portion of a slurry comprising terephthalic acid solids, acetic acid, and water from a process for making terephthalic acid with a first filtration medium to produce a first filtrate; (b) contacting a second portion of the slurry with a second filtration medium to produce a second filtrate; and (c) passing the first filtrate and the second filtrate to different locations in the process for making terephthalic acid. The first filtration medium comprises a filter cloth and less than 10 mm in thickness of solids on the filter cloth. The second filtration medium comprises a filter cloth and at least 10 mm in thickness of solids on the filter cloth. The second filtrate comprises a lower terephthalic acid solids content than the first filtrate.

### BRIEF DESCRIPTION OF THE DRAWING

FIG. 1 is a graph of the PTA solids concentration in the filtrate versus cake height on the filter cloth from Examples 1-3 below.

### DETAILED DESCRIPTION OF THE INVENTION

It has been surprisingly discovered that the efficiency of a filter for separating solids from liquid can be remarkably improved by first establishing a layer of the solids on the filter medium.

Thus, in one aspect, the present invention provides a process for separating solids from liquid in a slurry. The process comprises the steps of: (a) contacting a first portion of a slurry comprising solids dispersed in a liquid with a first filtration medium to produce a first filtrate; (b) contacting a second portion of the slurry with a second filtration medium to produce a second filtrate; and (c) passing the first filtrate and the second filtrate to different locations. The first filtration medium comprises less than 10 mm in thickness of a filter cake comprising the solids. The second filtration medium comprises at least 10 mm in thickness of a filter cake comprising the solids. The second filtrate comprises a lower solids content than the first filtrate.

Without wishing to be bound by theory, it is believed that the first filtrate will have a higher solids content than the second filtrate, because more solids will break through the filter medium as a cake (layer of solids) begins to form on the medium. The second filtrate will have a lower solids content than the first filtrate, because a portion of the solids that would normally break through the filter medium would be caught up in the filter cake.

The process of the invention may be applied to any solid/liquid system. For example, it may be applied to separate solids from an aqueous-based slurry or from an organic solvent-based slurry or from a slurry that contains both water and an organic solvent. The size of the solids can also vary, so long as the pore size of the filter medium is appropriately selected to capture at least some of the solids.

As used herein, the expression “solids content” refers to the concentration of solids in the liquid.

The process of the invention may be practiced using a variety of filter types. For example, suitable filter devices include a continuous vacuum belt filter, a continuous pressure drum filter, a vacuum drum filter, or combinations thereof.

The filter medium for use in the present invention is not particularly limited. For example, the filter medium may be cloth or membrane type.

The process of the invention can have various modes of operation. For example, in one mode, the process steps (a) and (b) may be carried out sequentially in the same filtration zone of a filtration device. In this mode, a first portion of the slurry is fed to the filtration zone until a layer of solids of a desired thickness (height) is collected on the filter medium. As it passes through the filter medium, the first filtrate is collected or withdrawn from the filtration zone and passed to a first location. Once the layer of solids having the desired thickness has been achieved on the filter medium, a second portion of the slurry is fed to the filtration zone to produce a second filtrate. The second filtrate is then passed to a second location, different from the first location where the first filtrate has been passed. In this mode, the filtration zone can have one or more slurry inlets and one or more filtrate outlets. If the filtration zone has only one filtrate outlet, a mechanism should be provided for collecting or withdrawing the first filtrate separately from the second filtrate. Examples of such a mechanism include a valve and a second conduit, or a three-port valve and associated conduits.

In another mode of operation, the process steps (a) and (b) are carried out in at least two filtration zones. The filtration zones may be provided in the same filtration device or in separate filtration devices. Each filtration zone can have its own slurry inlet and its own filtrate outlet, but there should be a mechanism for advancing the filter medium from the first filtration zone to the second filtration zone when the desired filter cake height is reached on the first filtration medium. An example of such a mechanism includes a conveyor belt. In this mode, a first portion of the slurry is fed to the first filtration zone until a layer of solids of a desired thickness (height) is collected on the first filter medium. At which time, the first filtration medium with the desired cake thickness can be passed to the second filtration zone to become the second filtration medium for contacting with a second portion of the slurry to produce a second filtrate. The first filtrate and the second filtrate are collected or withdrawn from their respective outlets, and passed to different locations.

The process of the invention may be carried out batch-wise or continuously.

In one embodiment, the first filtration medium comprises less than 15 mm in thickness of a filter cake comprising the solids, and the second filtration medium comprises at least 15 mm in thickness of a filter cake comprising the solids. In another embodiment, the first filtration medium comprises less than 20 mm in thickness of a filter cake comprising the solids, and the second filtration medium comprises at least 20 mm in thickness of a filter cake comprising the solids. In yet another embodiment, the first filtration medium comprises less than 25 mm in thickness of a filter cake comprising the solids, and the second filtration medium comprises at least 25 mm in thickness of a filter cake comprising the solids.

Alternatively, in one embodiment, the first filtration medium can have a filter cake of less than 30 mm in thickness, and the second filtration medium can have a filter cake of at least 10 mm in thickness. In another alternative embodiment, the first filtration medium can have a filter cake of less than 25 mm in thickness, and the second filtration medium can have a filter cake of at least 15 mm in thickness.

The cake on the second filtration medium may be permitted to rise to any desired height. However, as the cake height increases, the filtration rate may decrease, and the extent of the decrease may depend on a number of factors including the filtration device and conditions employed, and the type of solids forming the cake. Generally, for continuous filters, the cake height on the second filtration medium may rise as high as, for example, 25, 50, 100, 120, 140, 160, 180, or even 200 mm, without appreciably affecting the filtration rate. For batch filters, the cake height can be higher. Such cake heights are within the scope of the invention.

The process of the invention is particularly suited for separating terephthalic acid (TPA) solids in a product slurry from a process for making TPA.

Thus, in another aspect, the invention provides a method for generating a low solids content terephthalic acid oxidizer purge feed stream. The method comprises the steps of: (a) contacting a first portion of a slurry comprising terephthalic acid solids, acetic acid, and water from a process for making terephthalic acid with a first filtration medium to produce a first filtrate; (b) contacting a second portion of the slurry with a second filtration medium to produce a second filtrate; and (c) passing the first filtrate and the second filtrate to different locations in the process for making terephthalic acid. The first filtration medium comprises a filter cloth and less than 10 mm in thickness of solids on the filter cloth. The second filtration medium comprises a filter cloth and at least 10 mm in thickness of solids on the filter cloth. The second filtrate comprises a lower terephthalic acid solids content than the first filtrate. At least a portion of the second filtrate can be employed as the low solids content TPA oxidizer purge feed stream.

Steps (a) and (b) of the method can be carried out over a wide range of temperatures, e.g., from ambient to 200° C. or higher. The filter cloth can have a pore size of 20 to 50 microns.

All embodiments of the process for separating solids from liquid according to the invention discussed above are applicable to the method for generating a low solids content TPA oxidizer purge feed stream and are hereby incorporated by reference.

As discussed above, a process for making TPA typically includes an oxidation zone and a filtrate purge zone. In one embodiment, step (c) of the method according to the invention comprises (i) passing at least a portion of the first filtrate to the oxidation zone, and (ii) passing at least a portion the second filtrate to the purge zone. A portion of the second filtrate may also be passed to the oxidation zone.

In a TPA process, the product slurry would typically have a solids content of about 30 wt % or higher. In addition to the TPA solids, water, and acetic acid solvent; the slurry may include catalyst components, impurities, and oxidation by-products. The method according to the invention is particularly effective at removing solids from the TPA product slurry. In one embodiment of the invention, the second filtrate has less than 3,000 ppm of solids. In another embodiment of the invention, the second filtrate has less than 1,500 ppm of solids. In yet another embodiment, the second filtrate has less than 1,000 ppm of solids.

Due to its low solids content, the second filtrate may be passed to the purge zone without being passed to a batch pressure filter or a decanter centrifuge.

As used herein, the indefinite articles “a” and “an” mean one or more, unless the context clearly suggests otherwise. Similarly, the singular form of nouns includes their plural form, and vice versa, unless the context clearly suggests otherwise.

While attempts have been made to be precise, the numerical values and ranges described herein should be considered to be approximations. These values and ranges may vary from their stated numbers depending upon the desired properties sought to be obtained by the present invention as well as the variations resulting from the standard deviation found in the measuring techniques. Moreover, the ranges described herein are intended and specifically contemplated to include all sub-ranges and values within the stated ranges. For example, a range of 50 to 100 is intended to include all values within the range including sub-ranges such as 60 to 90 and 70 to 80.

This invention can be further illustrated by the following examples of preferred embodiments thereof, although it will be understood that these examples are included merely for purposes of illustration and are not intended to limit the scope of the invention. Unless otherwise indicated, all percentages are by weight.

### EXAMPLES

### Examples 1-3

In each of the examples, a PTA slurry was charged to a vacuum filter operated at 0.6 bar and flitted with a 43 micron PEEK cloth from SEFAR company. Varying amounts of an 80° C. terephthalic acid slurry were charged to the filter resulting in three filter cake heights: 10 mm; 20 mm; and 30 mm. Mother liquor (filtrate) was collected for each cake height and analyzed for ppm terephthalic acid.

The data for Examples 1 through 3 are shown in Table 1 below. The ppm of terephthalic acid below included both the solids and TPA in solution. The solubility of TPA in the mother liquor at 80° C. is about 250 ppm.

TABLE 1

| Example | Cake Height | Filtrate TPA |
|---|---|---|
| No. | (mm) | Concentration (ppm) |
| 1 | 10 | 2582 |
| 2 | 20 | 889 |
| 3 | 30 | 788 |

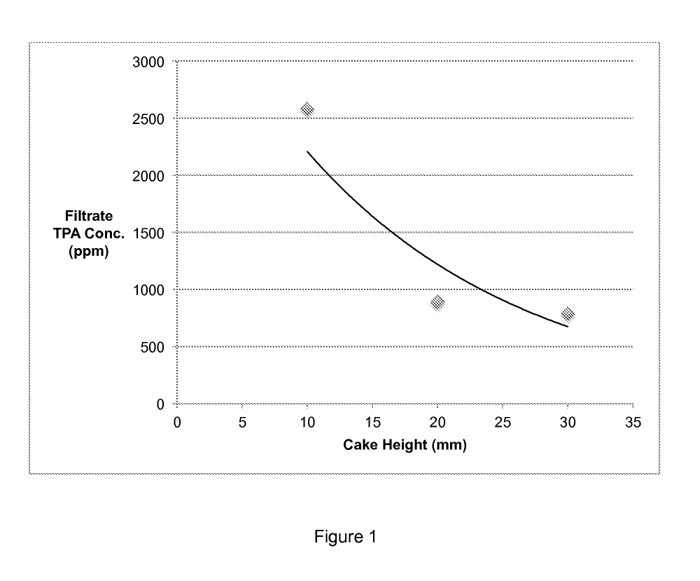

This data is depicted graphically in FIG. 1.

From FIG. 1, it can be seen that there was a dramatic decrease in the amount of TPA solids that broke through the filter cloth for a 20 mm cake versus a 10 mm cake. Therefore, establishing at least a 10 mm cake on the filter cloth of a terephthalic acid product filter prior to collecting oxidizer mother liquor for a purge feed stream can result in an oxidizer mother liquor purge feed stream with a low solids content.

The invention has been described in detail with particular reference to preferred embodiments thereof, but it will be understood that variations and modifications can be effected within the spirit and scope of the invention.

I claim:

1. A process for separating solids from liquid in a slurry, the process comprising:
(a) contacting a first portion of a slurry comprising solids dispersed in a liquid with a first filtration medium to produce a first filtrate;
(b) contacting a second portion of the slurry with a second filtration medium to produce a second filtrate; and
(c) passing the first filtrate and the second filtrate to different locations;
wherein the first filtration medium comprises less than 10 mm in thickness of a filter cake comprising the solids,
wherein the second filtration medium comprises at least 10 mm in thickness of a filter cake comprising the solids, and
wherein the second filtrate comprises a lower solids content than the first filtrate.

2. The process according to claim 1, wherein steps (a) and (b) are conducted sequentially in the same filtration zone of a filtration device.

3. The process according to claim 1, wherein the first filtration medium and the second filtration medium are located in separate filtration zones of a filtration device.

4. The process according to claim 1, wherein the first filtration medium and the second filtration medium are located in separate filtration devices.

5. The process according to claim 1, wherein steps (a) and (b) are conducted on a continuous vacuum belt filter, a continuous pressure drum filter, a vacuum drum filter, or combinations thereof.

6. The process according to claim 1, wherein the slurry is a product stream from a process for making terephthalic acid, and wherein the process for making terephthalic acid comprises an oxidation zone and a filtrate purge zone.

7. The process according to claim 6, wherein step (c) comprises (i) passing at least a portion of the first filtrate to the oxidation zone, and (ii) passing at least a portion the second filtrate to the purge zone.

8. The process according to claim 7, wherein the slurry comprises at least 30 wt % of solids, and the second filtrate comprises less than 1,500 ppm of solids.

9. The process according to claim 8, wherein the second filtrate comprises less than 1,000 ppm of solids.

10. The process according to claim 7, wherein the second filtrate is passed to the purge zone without being passed to a batch pressure filter.

11. A method for generating a low solids content terephthalic acid oxidizer purge feed stream, the method comprising:
(a) contacting a first portion of a slurry comprising terephthalic acid solids, acetic acid, and water from a process for making terephthalic acid with a first filtration medium to produce a first filtrate;
(b) contacting a second portion of the slurry with a second filtration medium to produce a second filtrate; and
(c) passing the first filtrate and the second filtrate to different locations in the process for making terephthalic acid;
wherein the first filtration medium comprises a filter cloth and less than 10 mm in thickness of solids on the filter cloth;
wherein the second filtration medium comprises a filter cloth and at least 10 mm in thickness of solids on the filter cloth; and
wherein the second filtrate comprises a lower terephthalic acid solids content than the first filtrate.

12. The method according to claim 11, wherein steps (a) and (b) are conducted sequentially in the same filtration zone of a filtration device.

13. The method according to claim 11, wherein the first filtration medium and the second filtration medium are located in separate filtration zones of a filtration device.

14. The method according to claim 11, wherein the first filtration medium and the second filtration medium are located in separate filtration devices.

15. The method according to claim 11, wherein steps (a) and (b) are conducted on a continuous vacuum belt filter, a continuous pressure drum filter, a vacuum drum filter, or combinations thereof.

16. The method according to claim 11, wherein the process for making terephthalic acid comprises an oxidation zone and a filtrate purge zone.

17. The method according to claim 16, wherein step (c) comprises (i) passing at least a portion of the first filtrate to the oxidation zone, and (ii) passing at least a portion the second filtrate to the purge zone.

18. The method according to claim 17, wherein the slurry comprises at least 30 wt % of terephthalic acid solids, and the second filtrate comprises less than 1,500 ppm of terephthalic acid solids.

19. The method according to claim 18, wherein the second filtrate comprises less than 1,000 ppm of terephthalic acid solids.

20. The method according to claim 17, wherein the second filtrate is passed to the purge zone without being passed to a batch pressure filter.
